(19) United States
(12) Patent Application Publication
(10) Pub. No.: US 2018/0364946 A1
(43) Pub. Date: Dec. 20, 2018

(54) DATA STORAGE DEVICE

(71) Applicant: Shannon Systems Ltd., Shanghai (CN)

(72) Inventor: Xueshi YANG, Cupertino, CA (US)

(21) Appl. No.: 15/959,452

(22) Filed: Apr. 23, 2018

(30) Foreign Application Priority Data
Jun. 20, 2017 (CN) 201710470906.3

(51) Int. Cl. G06F 3/06

(52) U.S. Cl. CPC G06F 3/0659; G06F 3/0688; G06F 3/0679; G06F 3/0604

(57) ABSTRACT

The invention relates to a data storage device and method, including at least one non-volatile storage and a controller with a two-layer structure. The two-layer structure includes a front end coupled to a host and a back end coupled to the non-volatile storage. The controller includes an instruction processor and at least one non-volatile storage controller. The instruction processor is arranged in the front end and communicates with the host and schedules operations of the data storage device in accordance with an external instruction. The non-volatile storage controller is arranged in the back end and controls the non-volatile storage in accordance with the schedule made by the instruction processor.

### CROSS REFERENCE TO RELATED APPLICATIONS

This Application claims priority of China Patent Application No. 201710470906.3, filed on Jun. 20, 2017, the entirety of which is incorporated by reference herein.

### FIELD OF THE INVENTION

The invention relates to a data storage device and method, especially relating to an expendable data storage device and method.

### DESCRIPTION OF THE RELATED ART

Flash storage is a common kind of non-volatile storage device which is erased and programmed electrically. For example, NAND flash can usually be used as a memory card, a Universal Serial Bus (USB) flash device, a Solid State Drive (SSD), an embedded Multimedia Card (eMMC), or a Universal Flash Storage (UFS), etc.

However, the original data storage device may be insufficient and need to be expanded when a large amount of data or high-speed data throughput is required. For example, the expansion comprises increasing storage capacity or processer numbers, etc. How to rapidly and effectively expand data storage devices is an important issue in the field of data storage. Therefore, the data storage device and a method for rapid and convenient expansion is desired.

### BRIEF SUMMARY OF THE INVENTION

In order to resolve the issue described above, the invention provides a data storage device and method for rapid and convenient expansion to meet data-access requirements.

In more detail, the data storage device of the invention comprises at least one non-volatile storage and a controller with a two-layer structure. The two-layer structure comprises a front end coupled to a host and a back end coupled to the non-volatile storage. The data storage device of the invention can be expanded in response to an increase of the non-volatile storage. No matter how many controllers have been expanded and increased in the back end of the data storage device, the arrangement of the front end remains the same. In other words, the quantity of each component in the front end isn't increased. Therefore, the controller with a two-layer structure provided by the invention can increase the arrangement of the controller in the back end without increasing the quantity of the components in the front end. Furthermore, the constitution and arrangement of each controller is the same, and it does not need to be redesigned for expansion. Therefore, the data storage device with a two-layer structure and the data storage method of the invention provide convenient and rapid expandability.

An embodiment of the invention provides a data storage device that comprises at least one non-volatile storage and a controller with a two-layer structure. The two-layer structure comprises a front end coupled to a host and a back end coupled to the non-volatile storage. An instruction processor, arranged in the front end, communicating with the host and scheduling operation of the non-volatile storage in accordance with an external instruction which is from the host and meets a first communication protocol; at least one non-volatile storage controller, arranged in the back end, converting the external instruction that meets the first communication protocol to a read-write instruction that meets a second communication protocol in accordance with the schedule made by the instruction processor, and controlling the operation of the non-volatile storage in accordance with the read-write instruction.

According to the above disclosed data storage device and method, persons skilled in the art may implement and obtain other attached features and advantages without departing from the spirit and scope of the invention.

### BRIEF DESCRIPTION OF THE DRAWINGS

The invention can be more fully understood by reading the subsequent detailed description with references made to the accompanying figures. It should be understood that the figures are not drawn to scale in accordance with general operation of industry. In fact, it is allowed to arbitrarily enlarge or reduce the size of components for clear illustration.

FIG. 1 shows a block diagram of a data storage device and a host in accordance with an embodiment of the disclosure.

FIG. 2 shows a block diagram of a data storage device and a host in accordance with another embodiment of the disclosure.

### DETAILED DESCRIPTION OF THE INVENTION

For the purposes of understanding features and advantages of the present invention, the following description exemplifies embodiments of the present invention together with reference to the accompanying figures. The following description is used to illustrate the spirit of the present invention but not to limit the scope of claims of the present invention, it should be understood that the following embodiments can be performed by software, hardware, firmware or a combination thereof.

Non-volatile storage adopted by a data storage device has many types, such as flash memory, Magnetoresistive RAM, Ferroelectric RAM, Resistive RAM, Spin Transfer Torque-RAM, STT-RAM, etc. for long-term data storage. In order to increase the throughput between a host and a data storage device, the present invention proposes a two-layer structure to implement a controller of the data storage device.

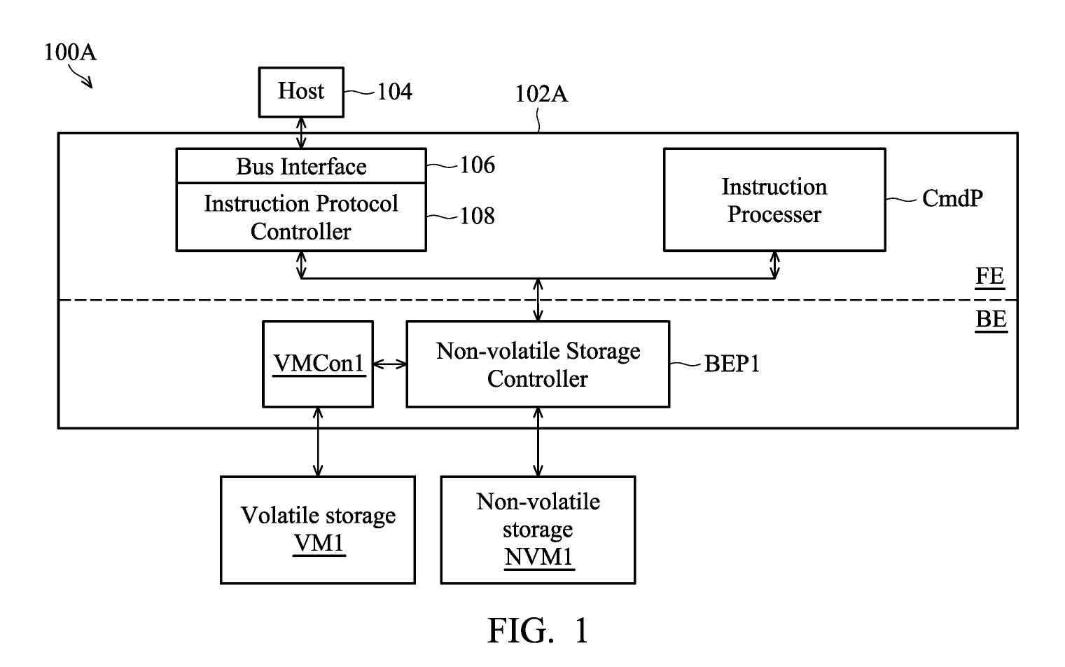

FIG. 1 shows a block diagram of a data storage device 100A and a host 104 in accordance with an embodiment of the disclosure. The data storage device 100A meets the specification of embedded MultiMediaCard (eMMC), Universal Flash Storage (UFS), Non-Volatile Memory express (NVMe), Advanced Technology Attachment (ATA), Parallel ATA (PATA), Serial ATA (SATA), and Small Computer System Interface (SCSI). Hereinafter, the specification of NVMe is used as an example for description, but the available specifications are not limited thereto. The host 104 can be a variety of electronic products, such as a mobile phone, tablet, laptop, navigation device, or automotive system, etc. As shown in FIG. 1, the data storage device 100A comprises a controller 102A, a volatile storage VM1, and a non-volatile storage NVM1. In detail, the volatile storage VM1 serves as a temporary storage of the non-volatile NVM1. The volatile storage VM1 can be built-in or externally connected to the controller 102A.

In some embodiments, the controller 102A may be divided into a front end (FE) or a back end (BE). The front end FE is responsible for communication between the data storage device 100A and the host 104. The back end BE is responsible for controlling the non-volatile NVM1 so that the host 104 can write or read the data to or from the non-volatile storage NVM1. In this way, the front end FE fully takes charge of data communication between the host 104 and the data storage device through the two-layer structure thereby improving data throughput between the host 104 and the data storage device 100A and lowering the debugging complexity of the front end FE and the back end BE.

As shown in FIG. 1, the host 104 is connected to the data storage device 100A via a bus interface 106. The host 104 outputs instructions (hereinafter referred to as external instructions) which meets the NVMe specification. The external instructions are scheduled by a command processor CmdP via an instruction protocol controller 108 and then are output to the back end BE for further processing. In other words, the command processor CmdP communicating with the host 104 via the bus interface 106 can simplify and speed up communication between the data storage device 100A and the host 104, and can schedule the external instructions in accordance with the priority setting or the order of reception.

In some embodiments, the bus interface 106 can be an eMMC, UFS, or PCIE interface. The instruction protocol controller 108 not only meets the NVMe specification, but also can meet the specification of ATA, PATA, SATA, SCSI, eMMC or UFS, etc. In some other embodiments, the instruction protocol controller 108 has an encryption mechanism which can encrypt the data sent by the host 104, and then send or assign the encrypted data to the back end BE via a bus interface. For example, the encryption mechanism comprises Advanced Encryption Standard (AES), or RSA encryption algorithm. Besides the encryption mechanism, the instruction protocol controller 108 further has an inspection mechanism for checking the correctness of the data, and the preferred inspection mechanism is Search Hash Algorithm (SHA).

In some embodiments, there is a high speed data bus between the front end FE and the back end BE. The high speed data bus can be a serial or parallel data bus, such as Advanced eXtensible Interface (AXI), which enables the communication between the front end FE and the back end BE. The front end FE and back end BE preferably have a bus controller or a bus arbitrator installed internally to coordinate the operation of the high speed data bus or the assignment of resource. The external instruction from the front end FE is sent and assigned to the back end BE for processing. As shown in FIG. 1, a non-volatile storage controller BEP1 operates a volatile storage VM1 via a volatile storage controller VMCon1 based on the received external instruction, to store the external instruction received by the non-volatile storage controller BEP1. Then, the non-volatile storage controller BEP1 converts the external instruction to a read-write instruction, and implements the read-write operation on the volatile storage NVM1 in accordance with the read-write instruction at an appropriate time. In some other embodiments, the non-volatile storage controller BEP1 can directly convert the external instruction to the read-write instruction, temporarily store the read-write instruction into the volatile storage VM1 which is operated by the volatile storage controller VMCon1, and implements the read-write operation on the volatile storage NVM1 in accordance with the read-write instruction at the appropriate time.

A controller with a two-layer structure of the present invention has a variety of processers (comprising an instruction processer CmdP, a non-volatile storage controller BEP1, and a volatile storage controller VMCon1). The communication mechanism between multiple processers is adopted, such as mailbox mechanism, to coordinate the operation between multiple processers.

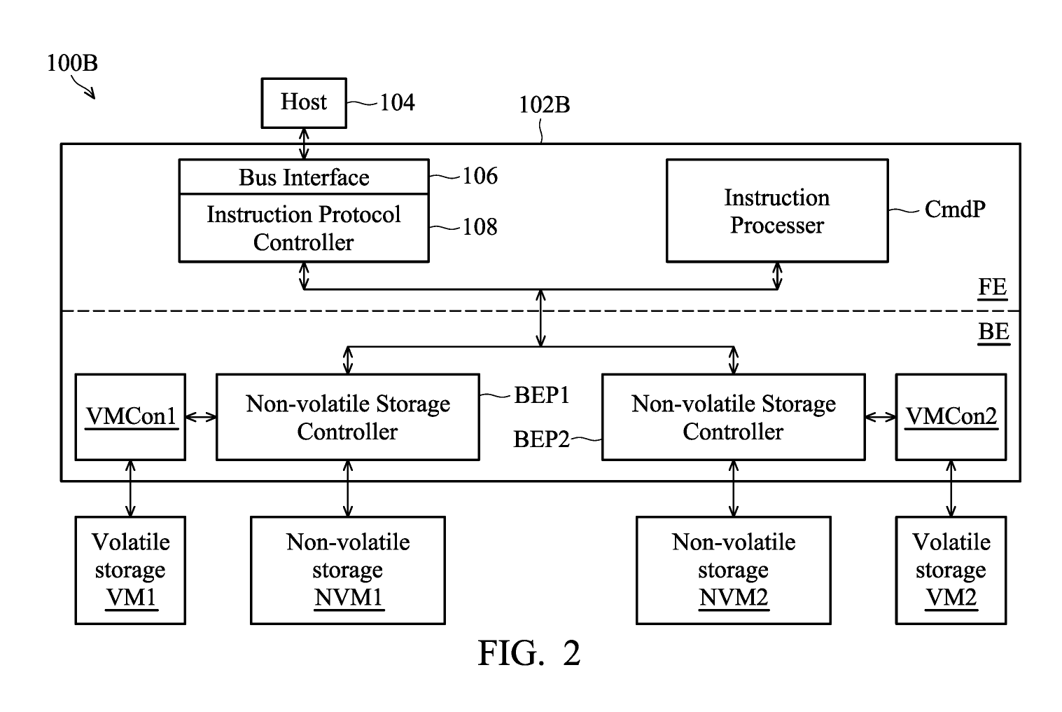

FIG. 2 shows a block diagram of the data storage device 100B and the host 104 in accordance with some other embodiments of the present invention. Due to having two back ends BE, in theory, the data storage device 100B thus can provide double data storage capacity than the data storage device 102A. In detail, in the data storage device 100B shown in FIG. 2, the storage capacity of the non-volatile storage NVM1 and NVM2 is identical or equally proportional. In FIG. 2, the data shunted (identically or in equal proportion) into the non-volatile storage NVM1 and NVM2. So the time for data accessing is decreased effectively, overall performance of the data storage device 100B is increased, and thus it is evident that high data throughput is feasible.

In some embodiments, the non-volatile storage NVM1 and NVM2 can be flash storage. The volatile storage VM1 and VM2 can be DRAMs. Moreover, the number of volatile storage VM1 and VM2, the non-volatile storage controller BEP1 and BEP2, and the volatile storage controller VMCon1 and VMcon2 corresponds to the number of non-volatile storage NVM1 and NVM2 in the data storage device 100B.

As shown in FIG. 2, the controller 102B is for controlling the back end BE which is controlled by the two of the controller 102A. For example, the first back end BE comprises the non-volatile storage NVM1 and the volatile storage VM1, and the second back end BE comprises the non-volatile storage NVM2 and the volatile storage VM2. In detail, In addition to the volatile storage controller VMCon1 and the non-volatile storage controller BEP1 which is included by the controller 102A, the controller 102B comprises the volatile storage controller VMCon2 and the non-volatile storage controller BEP2.

It should be noted that the configuration of the controller 102B is identical to or corresponds to that of the controller 102A based on the configuration of the non-volatile storage NVM1 and NVM2. When the storage capacity of the non-volatile storage NVM2 is the same as that of the non-volatile storage NVM1, the configuration of the non-volatile storage controller BEP1 is the same as that of the non-volatile storage controller BEP2. When the storage capacity of the non-volatile storage NVM2 is larger than that of the non-volatile storage NVM1, the controller 102B requires a controller with better performance (such as the volatile storage controller VMCon2 and the non-volatile storage controller BEP2) to improve the access speed of the non-volatile storage NVM2 with larger capacity, so that the access speed of the non-volatile storage NVM2 is identical to the access speed of the non-volatile storage NVM1 with smaller capacity. For example, the values of a Logical Block Address (LBA) which the external instruction corresponds to are #0, #2, #4 and #6. When the storage capacity of the non-volatile storage NVM2 is identical to that of the non-volatile storage NVM1, the external instruction that corresponds to #0 and #4 of the LBA is sent to the non-volatile storage controller BEP1, and the external instruction that corresponds to #2 and #6 of the LBA is sent to the non-volatile storage controller BEP2, so that the loading of the non-volatile storage controller BEP1 and the non-volatile storage controller BEP2 can be balanced. In contrast, if the storage capacity of the non-volatile storage NVM2 is larger than that of the non-volatile storage NVM1, the external instruction that corresponds to #2 of the LBA is sent to the non-volatile storage controller BEP1, and the external instruction that corresponds to #0, #4, #6 of the LBA is sent to the non-volatile storage controller BEP2, so that the non-volatile storage NVM2 with larger storage capacity can store or read more data.

In some embodiments, the storage capacity of the non-volatile storage NVM1 is identical to that of the non-volatile storage NVM2. In some other embodiments, the non-volatile storage NVM1 and NVM2 can serve as Redundant Array Independent Disks (RAID) to improve the reliability of data and the read-write performance of the data storage device 100B. In a first RAID mode, the non-volatile storage NVM1 and NVM2 mirror-map each other, and the data stored in the non-volatile storage NVM1 are identical to that of the non-volatile storage NVM2. In a second RAID mode, the non-volatile storage NVM1 and NVM2 store the data respectively. In a third RAID mode, the non-volatile storage NVM1 and NVM2 store the data respectively, wherein the non-volatile storage NVM2 not only stores the data, but further stores RAID parity codes of the non-volatile storage NVM1 and NVM2. Additionally, the RAID parity codes not only can be stored in the non-volatile storage NVM2 regularly, but also can be stored in both of the non-volatile storage NVM1 and NVM2 alternately. The data storage device 100B can provide many kinds of RAID mode from which users can select.

It should be noted that there are a variety of channels between the non-volatile storage NVM1/NVM2 and the non-volatile storage controller BEP1/BEP2, and the non-volatile storage controller BEP1/BEP2 evenly assigns data which is required for accessing the variety of channels, to write or read the data to or from the non-volatile storage NVM1/NVM2. For example, in the embodiment, there are four channels between the non-volatile storage NVM1 and the non-volatile storage controller BEP1, and the non-volatile storage controller BEP1 respectively sends or assigns four data to the non-volatile storage NVM1 via the four channels. Compared with transmitting all four data via the same channel, evenly assigning all data to each channel for transmitting as disclosed in the present invention can improve the efficiency of data transmission to avoid a delay of data transmission. It should be noted that the quantity of channels and the data transmission or assignment have been presented as examples only, and not limitations. Persons skilled in the art may arrange for another quantity of channels and data assignments without departing from the spirit and scope of the invention.

It should be noted that there is no direct correlation between the quantity of the front end FE and that of the back end BE. The preferred quantity of the front end FE is directly related to the bandwidth of the bus interface 106, and the preferred quantity of the back end BE is directly related to the bandwidth of the bus interface 106, the back end BE, and the access speed of the non-volatile storage. The lower access speed of the non-volatile storage is a bottleneck of the system performance for the data storage device 102A and 102B. The quantity of the front end FE is less than that of the back end BE, and the preferred quantity of the back end BE is even multiples of that of the front end FE. Therefore, the controller 102A and 102B with a two-layer structure as disclosed in the present invention can increase the arrangement of the back end BE in accordance with user requirements for system performance without modifying the front end FE. Moreover, the constitution and arrangement of the each back end BE controller is basically the same, therefore, the arrangement of the back end BE controller can easily be implemented to meet various requirements from users.

The method of the present invention, or its specific type or part thereof, can be implemented by program codes. The program codes can be stored in physical media, such as floppy disk, compact disc, hard disk, or any other machine readable (such as computer readable) storage media, and are not limited to any type of computer program product, wherein when the program codes are loaded and executed by the machine (such as the computer), the machine becomes the device for referring to the present invention. The program codes can be sent via some transmission media, such as wire, cable, optical fiber, or any other transmission types thereof, wherein when the program codes are received, loaded and executed by the machine (such as the computer), the machine becomes the device for referring to the present invention. During unit implementation processing for general purpose, the program codes combined with the processing unit can serve as a unique device for operation that is similar to a specific logic circuit.

The ordinal in the specification and the claims of the present invention, such as “first”, “second”, “third”, etc., has no sequence relation between each other, and is just for dividing two different components with the same name. In the specification of the present invention, the word “couple” refers to any kinds of direct or indirect electrical connection. The present invention is disclosed by the preferred embodiments as described above, however, the breadth and scope of the present invention should not be limited by any of the embodiments described above. Persons skilled in the art can make small changes and retouch without departing from the spirit and scope of the invention. The scope of the invention should be defined in accordance with the following claims and their equivalents.

What is claimed is:

1. A data storage device, comprising:
at least one non-volatile storage; and
a controller with a two-layer structure, wherein the two-layer structure comprises a front end coupled to a host and a back end coupled to the non-volatile storage, and the controller comprises:
an instruction processor, arranged in the front end, communicating with the host and scheduling operation of the non-volatile storage in accordance with an external instruction which is from the host and meets a first communication protocol; and
at least one non-volatile storage controller, arranged in the back end, converting the external instruction that meets the first communication protocol to a read-write instruction that meets a second communication protocol in accordance with the schedule made by the instruction processor , and controlling the operation of the non-volatile storage in accordance with the read-write instruction.

2. The data storage device as claimed in claim 1, wherein there are a variety of channels between the non-volatile storage and the non-volatile storage controller, and the non-volatile storage controller assigns data which is required for accessing the variety of channels, to write or read the data to or from the non-volatile storage.

3. The data storage device as claimed in claim 1, wherein the controller further comprises:
an instruction protocol controller, arranged in the front end, to support an instruction protocol of the data storage device.

4. The data storage device as claimed in claim 1, wherein the instruction protocol controller further encrypts the data from the host.

5. The data storage device as claimed in claim 1, wherein the at least one non-volatile storage comprises a first non-volatile storage and a second non-volatile storage, and the at least one non-volatile storage controller comprises a first non-volatile storage controller and a second non-volatile storage controller.

6. The data storage device as claimed in claim 5, wherein the instruction processor alternately sends or assigns the external instruction to the first non-volatile storage controller and the second non-volatile storage controller.

7. The data storage device as claimed in claim 6, wherein the first non-volatile storage controller or the second non-volatile storage controller converts the external instruction to a read-write instruction, and the first non-volatile storage controller or the second non-volatile storage controller accesses the first non-volatile storage or the second non-volatile storage in accordance with the read and write instruction.

8. The data storage device as claimed in claim 6, wherein the first non-volatile storage and the second non-volatile storage constitute a redundant array of independent disks (RAID).

9. The data storage device as claimed in claim 6, wherein the data stored by the first non-volatile storage is the same as that stored by the second non-volatile storage.

10. The data storage device as claimed in claim 6, wherein the data stored by the first non-volatile storage is different from that stored by the second non-volatile storage.

11. The data storage device as claimed in claim 6, wherein the data stored by the first non-volatile storage is different from that stored by the second non-volatile storage, and the second non-volatile storage further stores an authentication code of the data stored by the first non-volatile storage and the second non-volatile storage.

12. The data storage device as claimed in claim 1, wherein the instruction processor schedules the operation of the data storage device in accordance with a logical block address (LBA) of the external instruction.
